(19) United States
(12) Patent Application Publication
(10) Pub. No.: US 2004/0178018 A1
(43) Pub. Date: Sep. 16, 2004

(54) Folding ladder for concrete mixer trucks

(75) Inventor: Ronald E. Christenson, Parsons, TN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN (US)

(21) Appl. No.: 10/389,369

(22) Filed: Mar. 14, 2003

(51) Int. Cl. E06C 9/00

(52) U.S. Cl. 182/97

(57) ABSTRACT

A two-section folding ladder assembly is disclosed secured to a pair of spaced platforms including an upper platform and a lower platform fixed to a truck. The ladder is arranged for manual deployment between a folded stowed position and an extended position facilitating access to the upper platform. The upper ladder section has an upper end pivotally secured to the upper platform and a lower end pivotally secured to the lower ladder section. The lower ladder section has an upper end pivotally attached to both the outer end of the lower platform and the lower end of the upper ladder section in a manner such that the lower ladder section is free to pivot between a folded position next to the upper ladder section and an extended position in which the upper ladder section and the lower ladder section combine to form a straight continuously aligned ladder structure.

### BACKGROUND OF THE INVENTION

I. Field of the Invention

The present invention relates generally to ladders mounted on vehicles for facilitating access to and from upper areas of the vehicles. More particularly, the present invention relates to folding ladders attached to transit concrete mixing trucks which enable quick access to the upper reaches of the truck so that one may observe the interior of the mixing drum and the charge hopper associated with the truck. These ladders are of the folding type so that they may be stowed in a convenient, out of the way, position when not in use.

II. Related Art

Current transit mixing vehicles include a drum mounted for rotation about an inclined axis and an opening on the raised end which serves both to receive materials to be mixed and to discharge concrete during a pour. These drums are typically provided with fixed spiral mixing blades which move the ingredients toward the lower end of the drum for mixing as the drum is rotated in a first direction and which move the material upward and discharge the mixed ingredients when the drum is rotated in the opposite direction. To facilitate the loading of the drum, a funnel shaped charge hopper is mounted in relation to the drum opening and is used to introduce materials released from above into the drum for mixing. An outlet collector chute is also provided leading from the opening to collect and direct the concrete as it is being discharged from the drum. Trouble-shooting and servicing the apparatus having to do with charging and discharging and the need from time to time to observe the contents of or inside of the drum requires easy access to the upper most reaches of the vehicle. To facilitate this, folding ladders have been devised which, when unfolded and extended, enable quick access to observe the upper most portions of the vehicle as desired. These ladders are attached to a support assembly which carries the upper portion of the drum and which are fastened to the truck chassis.

FIGS. 1a-1c depict the construction and operation of one typical prior art folding ladder attached to the structure of a concrete mixing truck or the like. While the views 1a-1c show but one side of the ladder, it will be understood that the further or unobserved side of the ladder is symmetrically identical. The ladder generally at 10 includes an upper ladder section 12 and a lower ladder section 14. One of a spaced pair of parallel side or leg members of each, section is respectively shown at 16 and 18. The plurality of substantially horizontal upper section climbing steps are shown by 20 and similar lower section steps are shown at 22. The side members of the upper ladder section 12 are secured between an upper platform 24 and a lower platform 26 as at 28 and 30, respectively. Attachment to the lower platform 26 is accomplished through spaced side gusset members one of which is depicted at 32. Platforms 24 and 26 are fixed to metal plate 34 associated with the rear pedestal structural support for the concrete mixing drum of a transit concrete mixing truck (not shown).

Lower ladder section 14 is pivotally connected to spaced side gusset members as at 32 using one pivot joint for each member as at 36. A truck fender outline is depicted by 38. The lower platform is bolted to a mounting plate 40 fixed to plate 34 as at 42. As shown in FIG. 1a-1c the deployed ladder typically subtends an angle of 84.3° with the horizontal making it quite steep for the climber. In addition, the upper and lower ladder sections 12 and 14 are offset when deployed and the distance between the upper most step of the lower section 14 and because of this the lowest step of the upper section 12 differs from the space between in either the upper section or the lower section.

Although ladders such as those illustrated in FIGS. 1a-1c have met with some success, there has been a need for a foldable ladder assembly which is easily stored and deployed in which the deployed ladder is somewhat less steep than prior ladders and in which the upper ladder section and lower section form a continuously aligned ladder structure when the ladder is in a fully extended position.

### SUMMARY OF THE INVENTION

By means of the present invention there is provided a ladder assembly securable to spaced platforms fixed to the drum support structure of a concrete mixing truck or the like and designed for manual deployment between a folded or stowed position and an extended or deployed position. The ladder stores out of the way and protrudes very little beyond the confines of the truck body in the stowed or folded position. The ladder facilitates access to the upper platform of the vehicle to inspect charging and discharging equipment and provide access to inspect the interior of the drum itself.

The ladder assembly includes an upper platform secured to the vehicle of interest. The upper ladder section is provided with a plurality of spaced climbing steps attached between a pair of spaced parallel side members or legs. The upper ladder section has the upper end of its side members pivotally secured to the upper platform. A lower platform is provided which includes an inner end and an outer end. The inner end is secured to the vehicle structure in a manner which allows an amount of vertical play in the outer end as by using pivot joints. A pair of spaced pivot lugs or gusset members are attached to the outer end of the lower platform which carry the upper end of the lower ladder section which also includes a plurality of spaced climbing steps attached between spaced parallel side members or legs. The upper ends of the lower ladder section are pivotally or jornal mounted to the pivot lugs or gusset members.

The lower ladder section has a free lower end and, as indicated, an upper end pivotally attached to the outer end of said lower platform utilizing the gusset members. The upper ends of the side members of the lower ladder section are also pivotally attached to the lower ends of the side members of the upper ladder section using lobes on the upper ends of the side members of the lower ladder section in a manner such that the upper portion of the lower ladder section and the lower portion of the upper ladder section pivot in relation to each other and also in relation to the lug or gusset members mounted to the lower platform in a manner such that when the lower ladder section pivots between a folded position next to the upper ladder section and an extended position the upper ladder section and the lower ladder section combine when fully extended to form a continuously aligned ladder structure. The aligned ladder structure also subtends a reduced angle between the ladder and the horizontal with regard to the angle of the stowed structure and of most such ladders making it easier to climb.

In order for the lower platform to accommodate the folding and unfolding of the ladder, the lower platform must be mounted in a manner which allows vertical displacement of the outer end as by using hinges (pivot mount) or another type of flexible mount for securing the inner end to the vehicle.

As previously indicated, when it is deployed, the ladder of the invention subtends an angular position that is less steep, and therefore easier to use, given the ladder is folded. Thus, a ladder which subtends an angle of 84.3° when fully folded may subtend an angle of only 78.8° when fully extended. It is further noteworthy that in the preferred arrangement the two foldable ladder sections pivot together in such a manner that when the ladder is extended all the climbing steps are not only separated by an equal distance including the transition steps surrounding the fold joint but they are also aligned in a common plane.

In addition to using a pivot mount for the lower platform, the platform may, for example, be mounted utilizing mounting bolts and rubber washers and grommets which affords sufficient flexibility for the outer end of the platform to accommodate the folding and unfolding of the ladder itself. This system further includes a locking device for locking the ladder in a folded position.

### BRIEF DESCRIPTION OF THE DRAWINGS

In the drawings wherein like reference characters are used to designate like parts throughout the same:

FIG. 1a illustrates a side elevational view of a particular prior art folding truck ladder in a folded or stowed disposition;

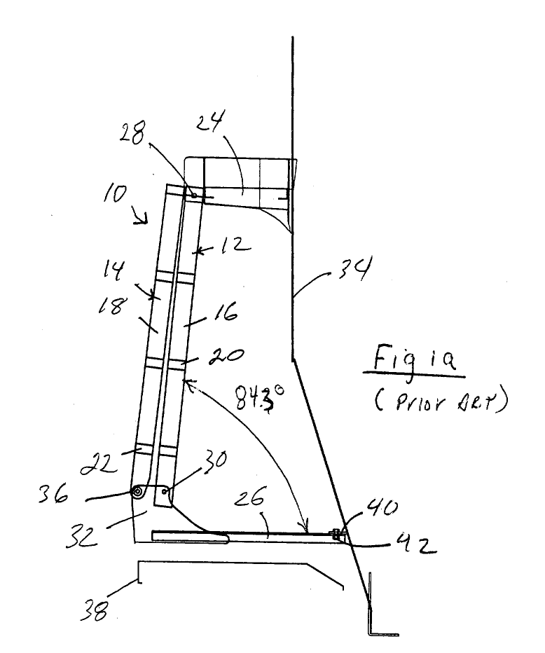

FIG. 1b is similar to that of FIG. 1a with a ladder partially unfolded;

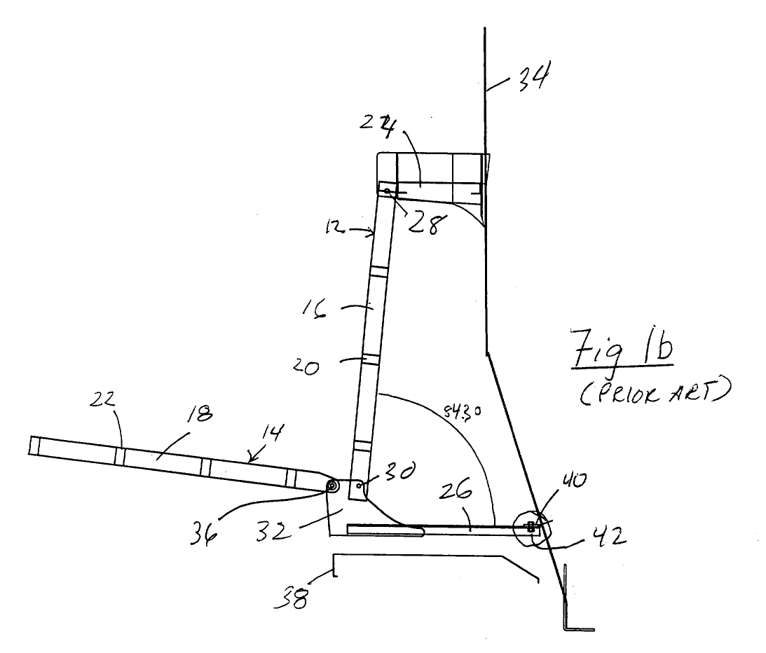

FIG. 1c is a view similar to that of FIGS. 1a and 1b with the ladder fully extended;

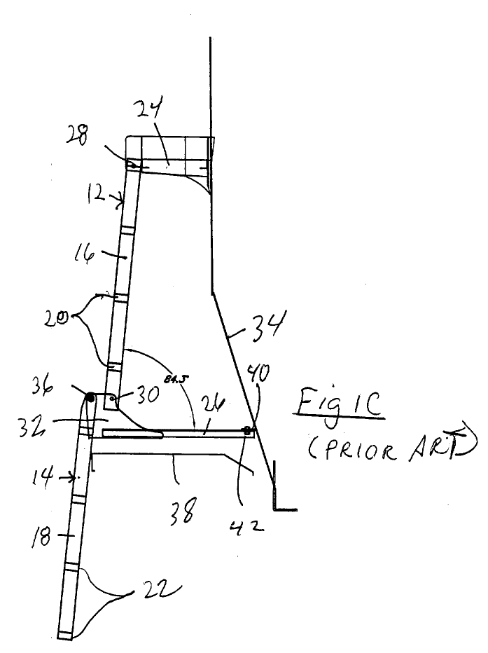

FIG. 2a illustrates a side elevational view of a folding ladder configured in accordance with an embodiment of the present invention in the folded or stowed orientation;

FIG. 2b is a side elevational view similar to FIG. 2a with a ladder partially unfolded;

FIG. 2c is a view similar to that of FIGS. 2a and 2b with the ladder shown fully extended or deployed;

FIG. 3 is an enlarged side view of the middle section of the ladder in FIGS. 2a-2c to clarify certain details;

FIGS. 4 and 5 are greatly enlarged side views showing alternate attachment details of the lower platform of the ladder of the invention;

FIG. 6 is a side elevational view of a transit concrete mixer truck equipped with an embodiment of the folding ladder of the invention.

### DETAILED DESCRIPTION

The following detailed description is directed to one or more specific embodiments of the ladder assembly of the invention. The embodiments as described are meant by way of example rather than limitation and it is believed that other modifications could occur to those skilled in the arts that would also exemplify the present invention.

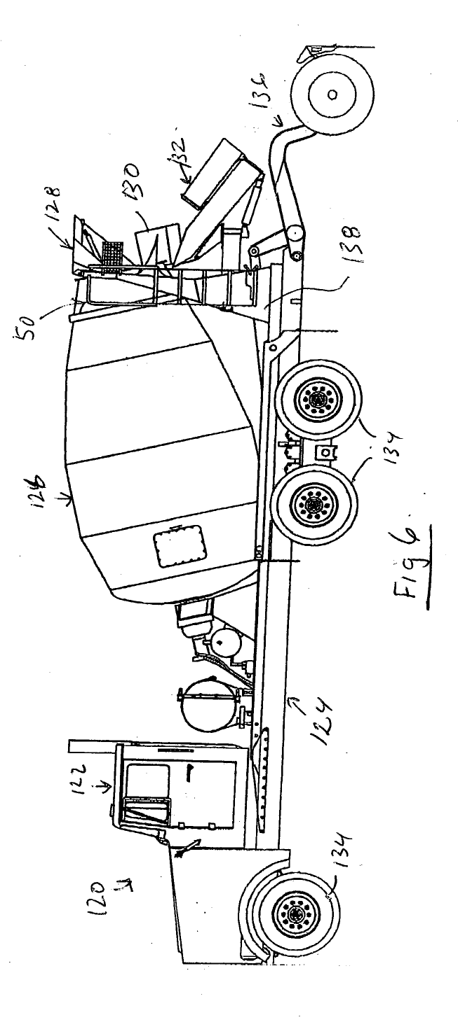

FIG. 6 depicts a side elevational view of a transit concrete mixer truck generally at 120 which includes a cab section 122 mounted on a heavy chassis frame 124 and a concrete mixing drum 126 mounted for rotation on the chassis 124. The vehicle 120 further includes a loading hopper assembly 128, collector and discharge chutes at 130 and 132, respectively. The vehicle 120 further includes supporting wheels 134 and an auxiliary or tandem axle is shown deployed at 136. The support structure for the upper portion of the rotating drum includes a rear pedestal 138 and a ladder configured in accordance with the present invention as shown mounted from the rear pedestal support structure generally at 50. The ladder is shown in the folded or stowed position.

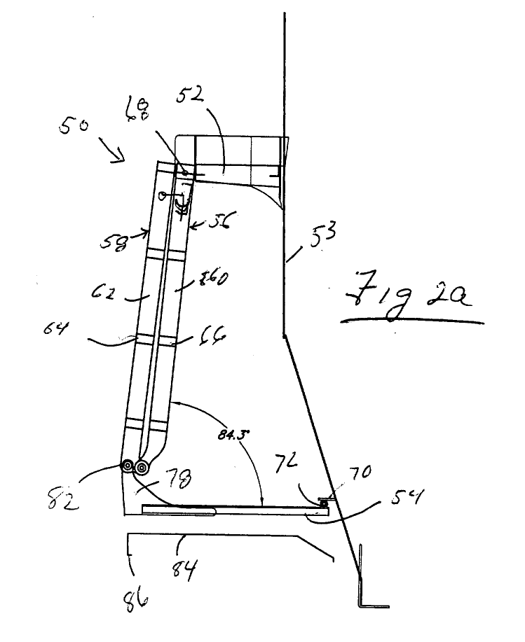

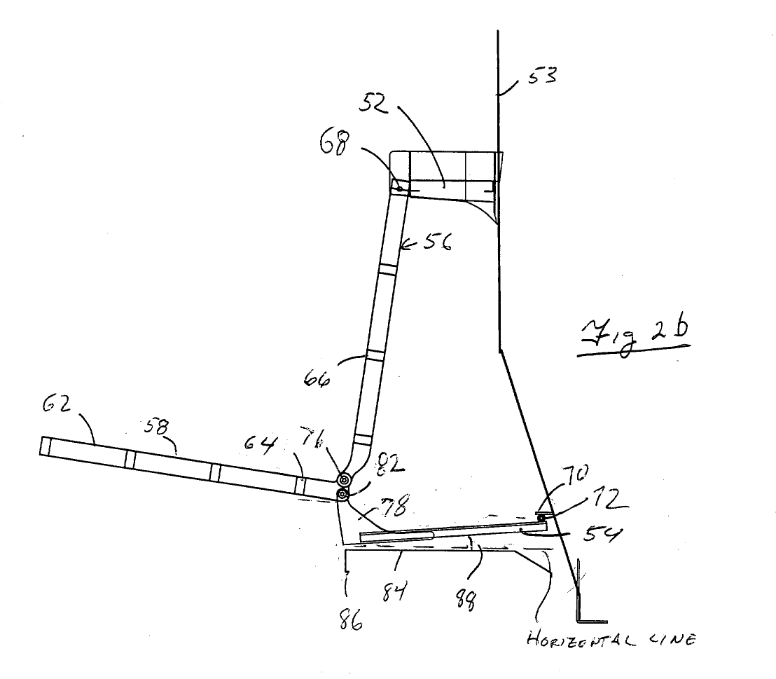

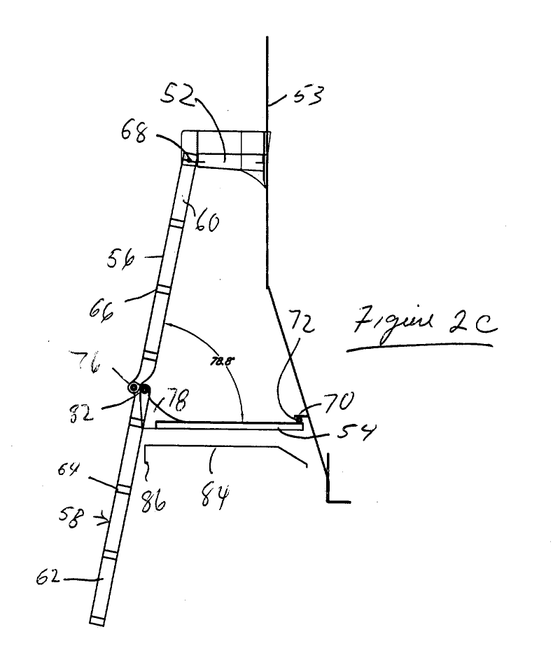

The drawing FIGS. 2a-2c depict a construction and positioning of a typical folding ladder attached to a truck body or the like in accordance with one embodiment of the present invention. While the views 2a-2c are limited to depicting one side of the ladder of the invention, it will be understood that the un-illustrated side is constructed in the same manner making the assembly symmetrically identical as shown in FIG. 6. FIG. 2a depicts a ladder assembly in accordance with the invention generally at 50. The assembly includes an upper platform 52, a lower platform 54. The ladder includes an upper ladder section 56 and a lower ladder section 58 each of which are constructed of spaced parallel side or leg members each one of which is respectively shown at 60 and 62. A plurality of rungs or climbing steps are provided which are substantially horizontally disposed which span the distance between the spaced parallel side members. They include lower ladder section climbing steps 64 and upper ladder section climbing steps 66.

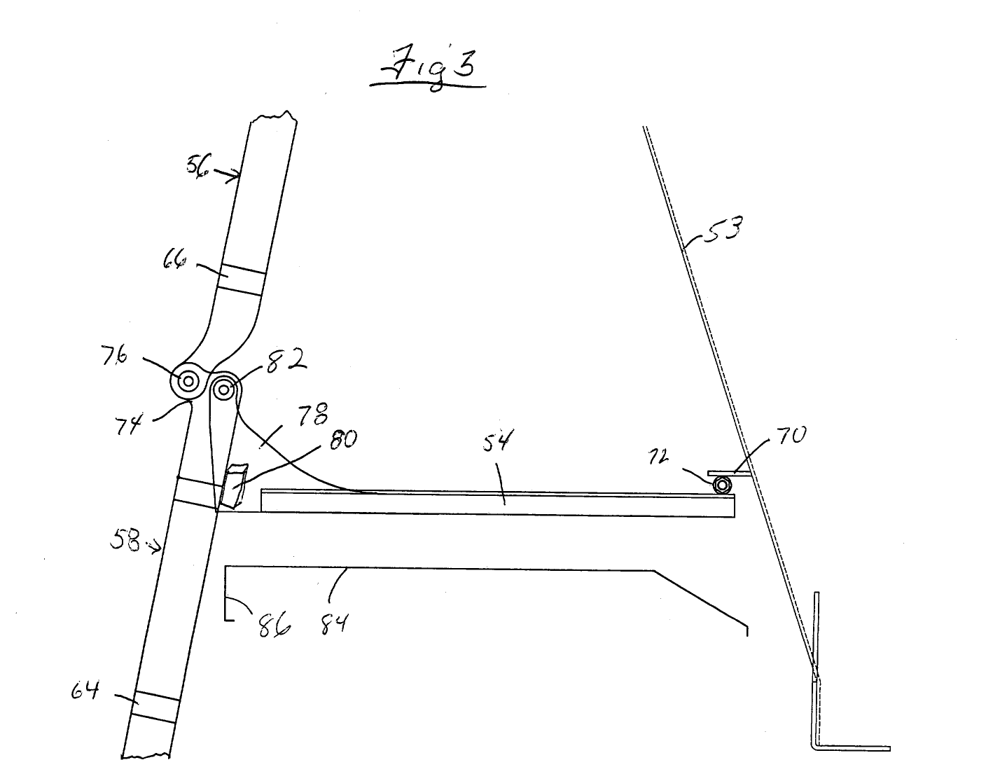

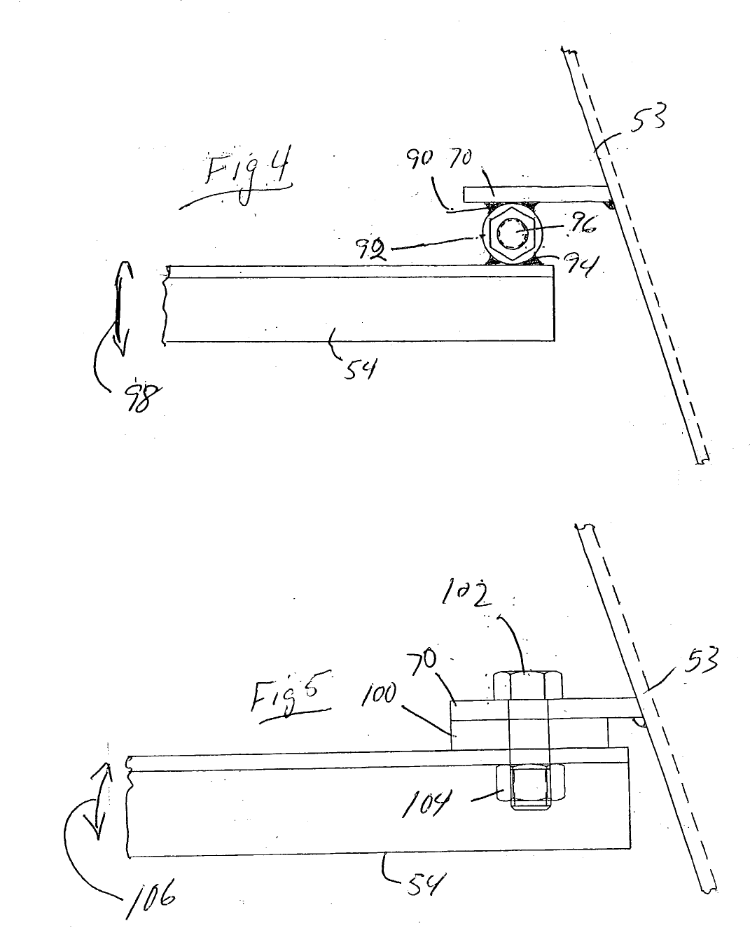

The upper ends of the side members of upper ladder section 56 are pivotally mounted to the upper platform 52 using spaced pivot joints one of which is shown at 68. Lower platform 54 is mounted so as to allow its outer edge to travel vertically at least a limited amount. In FIGS. 2a-2c, 3 and 4 the lower platform is pivotally mounted using a pedestal mounting plate 70 and associated spaced pivot joints 72 one of which is at 72. This mounting is also shown in the enlarged spaced fragmented view of FIG. 4. Note that as is best seen in FIG. 3, the top of sides of the lower ladder section 58 include lobe or ear shapes as at 74 which accommodate lower pivot joints 76 for the lower end of the side members of upper ladder section 56. The upper end of the side members of the lower ladder section 58 also pivotally mounted by pivot joints for the lower ladder section 58 one of which is shown at 82 and which attach the lower ladder section 58 to the lower platform 54. The pivot joints 82 are carried on platform pivot lugs or gussets 78 fixed to the platform 54 and a positive ladder stop is illustrated at 80.

The shape of the lobes 74 of the upper end of the lower ladder section 58 together with the spacing of the pivot joints 76 and 82 enables the upper section and the lower section 58 to pivot relative to each other in a manner which enables the ladder to be fully aligned when extended and fully tucked together with the upper and lower steps aligned horizontally in the folded our stowed position. As can be seen from the FIGS. 2a-2c, in order for the ladder to pivot from the folded or stowed position to the fully extended position the platform 54 must deflect downward a short distance as shown in FIG. 2b at 88 to allow the rotation of the pivot joints relative to each other. This is enabled by the pivot joint 72 in the mounting of the lower platform 54.

As further illustrated in the figures, a truck fender depicted as 84 and having an outer edge 86 is barely exceeded in width by the ladder in its folded or stowed position as shown in FIG. 2a and in the fully deployed position of the ladder as shown in FIGS. 2c and 3a, the fully extended ladder is outside of and does not interfere with the outer edge 86 of the fender 84. The ladder further includes a conventional manual locking device for holding the folded ladder in place (now shown).

The mounting of the platform 54 to the plate 53 in a manner which allows some deflection of the outer end of the platform 54 is best shown in the enlarged fragmentary views of FIGS. 4 and 5. Thus, in FIG. 4 there is shown platform mounting tab 70 welded to the member 53 and inside bushings (not shown) are welded to the platform mounting tab 70 and outside bushings as at 92 are shown welded to the platform 54 as at 94. These are connected in pivotal fashion utilizing through pivot bolts as at 96. This enables the platform 54 to pivot vertically about the pivot bolts 96 as shown by the arrow 98.

FIG. 5 shows an alternate mounting of the platform 54 to the member 53 utilizing a vertical type mounting with thick rubber washers or grommets at 100 and vertical mounting bolts 102 with hex nuts 104 bolting the platform 54 to the platform-mounting tab 70. There is enough play in the resilient members 100 such that the platform can pivot or flex a sufficient amount as shown by the arrow 106 to accommodate the folding and unfolding of the ladder assembly of the invention.

This invention has been defined herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A ladder assembly securable to a truck or the like for manual deployment between a folded stowed position and an extended position facilitating access to a platform, said ladder assembly comprising:
(a) an upper platform secured to a vehicle of interest;
(b) an upper ladder section including a frame with a plurality of spaced climbing steps and having an upper end pivotally secured to said upper platform and a lower end;
(c) a lower platform having an inner end and an outer end wherein said inner end is fastened to said vehicle in a manner that allows sufficient vertical motion of said outer end to accommodate ladder folding;
(d) a lower ladder section including a frame with a plurality of spaced climbing steps and having a first end pivotally attached to both said outer end of said lower platform and the lower end of said upper ladder section in a manner such that said lower ladder section is free to pivot between a folded position next to said upper ladder section and an extended position in which said upper ladder section and said lower ladder section combine to form a straight continuously aligned ladder structure.

2. A ladder assembly as in claim 1 wherein all climbing steps are equally spaced when said ladder is an extended position.

3. A ladder assembly as in claim 1 wherein said ladder in an extended position assumes an angular position that is less steep than the angular position assumed when said ladder is in a folded position.

4. A ladder assembly as in claim 1 wherein pivot joints attaching said first end of said lower ladder section to the said outer end of said lower platform are spaced from pivot joints attaching the lower end of said upper ladder section to said lower ladder section and wherein said outer end of said lower platform is movable vertically a sufficient amount to accommodate unfolding and alignment of said upper ladder section and said lower ladder section in an extended position.

5. A ladder assembly as in claim 4 wherein said inner end of said lower platform is pivotally attached to said vehicle.

6. A ladder assembly as in claim 1 wherein climbing steps of said upper ladder section align with climbing steps of said lower ladder section when said ladder is in a folded position.

7. A ladder assembly as in claim 4 wherein all climbing steps are equally spaced when said ladder is an extended position.

8. A ladder assembly as in claim 4 wherein said ladder in an extended position assumes an angular position that is less steep than the angular position assumed when said ladder is in a folded position.

9. A ladder assembly as in claim 4 wherein climbing steps of said upper ladder section align with climbing steps of said lower ladder section when said ladder is in a folded position.

10. A ladder assembly securable to a pair of vertically spaced platforms for manual deployment between a folded stowed position and an extended position facilitating access to an upper platform, said ladder assembly comprising:
(a) an upper platform secured in place of interest;
(b) an upper ladder section including a frame with a plurality of spaced climbing steps and having an upper end pivotally secured to said upper platform and a lower end;
(c) a lower platform having an inner end and an outer end wherein said inner end is fastened in place in a manner that allows sufficient vertical motion of the outer end to accommodate ladder folding;
(d) a lower ladder section including a frame with a plurality of spaced climbing steps and having a first end pivotally attached to both said outer end of said lower platform and the lower end of said upper ladder section in a manner such that said lower ladder section is free to pivot between a folded position next to said upper ladder section and an extended position in which said upper ladder section and said lower ladder section combine to form a straight continuously aligned ladder structure.

11. A ladder assembly as in claim 10 wherein pivot joints attaching said first end of said lower ladder section to the said outer end of said lower platform are spaced from pivot joints attaching the lower end of said upper ladder section to said lower ladder section and wherein said outer end of said lower platform is movable vertically a sufficient amount to accommodate unfolding and alignment of said upper ladder section and said lower ladder section in an extended position.

12. A ladder assembly as in claim 11 wherein said inner end of said lower platform is pivotally attached.

13. A ladder assembly as in claim 11 wherein said ladder in an extended position assumes an angular position that is less steep than the angular position assumed when said ladder is in a folded position.
